(19) United States
(12) Patent Application Publication
(10) Pub. No.: US 2009/0220169 A1
(43) Pub. Date: Sep. 3, 2009

(54) IMAGE ENHANCEMENT

(75) Inventors: Eric P. Bennett, Kirkland, WA (US); Bradley Hinkel, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/038,816

(22) Filed: Feb. 28, 2008

(51) Int. Cl. G06K 9/40

(52) U.S. Cl. 382/268

(57) ABSTRACT

A bilateral filter is implemented to allow a digital image to be enhanced while mitigating the formation of ringing artifacts or halos within the image. The bilateral filter allows the digital image to be decomposed into a detail feature image and a large-scale feature image, where the image's textures are primarily comprised within the detail image, and the image's edges are primarily comprised within the large-scale feature image. By decomposing the image into these two sub-images and then globally scaling their respective magnitudes, it is possible to adjust the textures within the image substantially independent of the edges in the image and vice versa. This allows the apparent amount of texture in the scene to be enhanced while mitigating the formation of ringing artifacts or halos around edges in the image.

### BACKGROUND

It is appreciated that certain techniques can be used to improve the quality of digital images. For example, “unsharp mask” algorithms may be implemented to enhance the perceived texture of digital images. However, such unsharp mask algorithms are based on non-edge preserving Gaussian smoothing filters. That is, unsharp mask algorithms essentially separate low frequency image components from high frequency image components via a Gaussian smoothing filter. This allows the respective components to be modulated by a constant to adjust their relative contributions. Generally, the high frequency components comprise the textures and some contributions from the edges within the images, while the low frequency components comprise large smooth regions plus the remaining edge contributions. Thus, the high frequency components can be modulated (e.g., increased) to accentuate textures as desired. However, since the high frequency components also comprise some portion of the edges within the image (when separated out with Gaussian smoothing filters), the edges within the image are also enhanced when textures are accentuated by modulating high frequency components. While this is generally not an issue for small amounts of enhancement, it becomes problematic when more substantial adjustments are made. For example, when the high frequency components are increased beyond a certain threshold, ringing artifacts or halos may be introduced around sharp edges in a scene. Such ringing artifacts or halos are undesirable, at least, because they can distract the viewer by introducing erroneous edges. Accordingly, there is room for improvement in digital image enhancement.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

As provided herein, the quality of a digital image can be enhanced while mitigating the formation of ringing artifacts or halos within the image. That is, bilateral filtering is implemented to allow textures and edges of an image to be adjusted separately. More particularly, bilateral filtering is used to decompose an image into two component images: a detail feature image and a large-scale feature image, where the image's textures are primarily comprised within the detail image, and the image's edges are primarily comprised within the large-scale feature image. By decomposing the image into these two sub-images and then globally scaling their respective magnitudes, it is possible to adjust the textures within the image substantially independent of the edges in the image and vice versa. It can be appreciated that this allows the apparent amount of texture in the scene to be enhanced while mitigating the formation of ringing artifacts or halos around edges in the image.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method for digital image enhancement.

FIG. 2 illustrates an exemplary digital image.

FIG. 3 illustrates an exemplary digital image where ringing artifacts or halos are introduced in the image due to the type of enhancement mechanism(s) employed.

FIG. 4 illustrates an exemplary digital image where the details/textures of the image are independently enhanced as provided herein.

FIG. 5 illustrates an exemplary digital image where the large-scale/edges of the image are independently enhanced as provided herein.

FIG. 6 illustrates an exemplary digital image where both the details/textures and large-scale/edges of the image are enhanced as provided herein.

FIG. 7 is a component block diagram illustrating an exemplary system configured to facilitate digital enhancement.

FIG. 8 is a component block diagram illustrating an exemplary digital enhancement technique as provided herein.

FIG. 9 is an illustration of an exemplary slider control that may be used to adjust details/textures of a digital image as provided herein.

FIG. 10 is an illustration of an exemplary slider control that may be used to adjust large-scale/edges of a digital image as provided herein.

FIG. 11 is an illustration of an exemplary computer-readable medium comprising processor-executable instructions configured to embody one or more of the provisions set forth herein.

FIG. 12 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

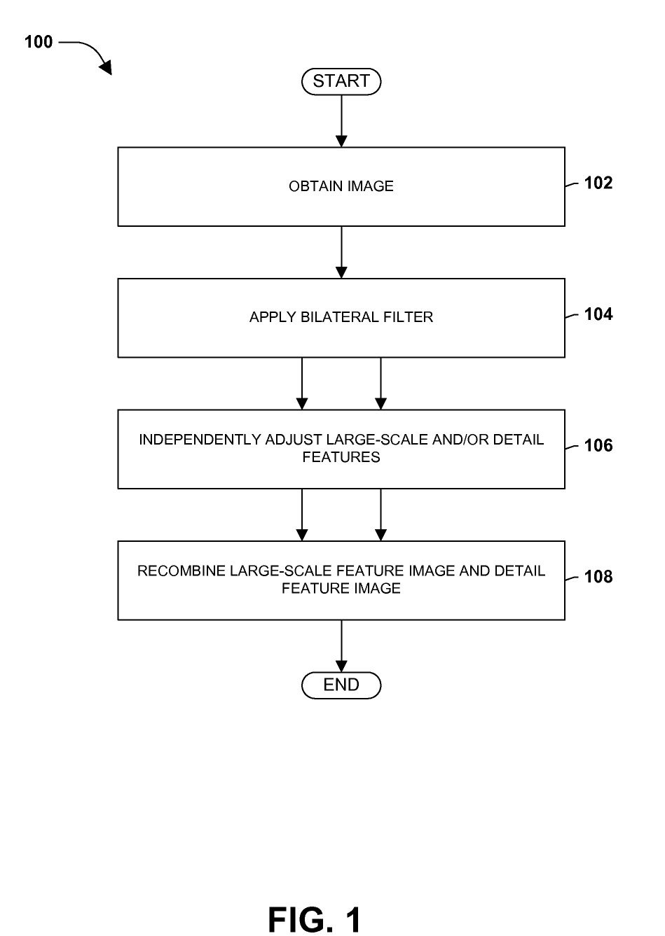

Turning initially to FIG. 1, an exemplary methodology 100 is illustrated for enhancing a digital image by separately adjusting the textures (e.g., details) and edges (e.g., large-scale features) of the image. At 102 the image to be processed is obtained, and a bilateral filter is applied to the image at 104. The bilateral filter effectively separates the image into two component images: a detail feature image and a large-scale feature image, where the image's textures are primarily comprised within the detail image, and the image's edges are primarily comprised within the large-scale feature image. More particularly, the bilateral filter outputs the large-scale features, and the detail features correspond to the difference between the original image and the large-scale features.

With the image decomposed into a detail (e.g., texture) image and a large-scale (e.g., edge) image, the respective magnitudes of the different images are adjusted independently at 106 to achieve a desired result. Once the detail and large-scale image are adjusted (independently) as desired, these images are recombined at 108 to render the original, but adjusted, base image, and the methodology ends thereafter. It will be appreciated that two arrows are illustrated between 104 and 106, and between 106 and 108. This is to illustrate that the detail and large-scale images are separate images and that they can be independently adjusted or otherwise acted upon as desired before being recombined into a single image at 108. It will also be appreciated that it may be advantageous to perform bilateral filtering operations logarithmically. Accordingly, an optional first logarithmic operation may be performed on the subject image just after it is acquired at 102 and a second logarithmic (e.g., exponent or inverse logarithmic) operation may be performed just after the recombination at 108.

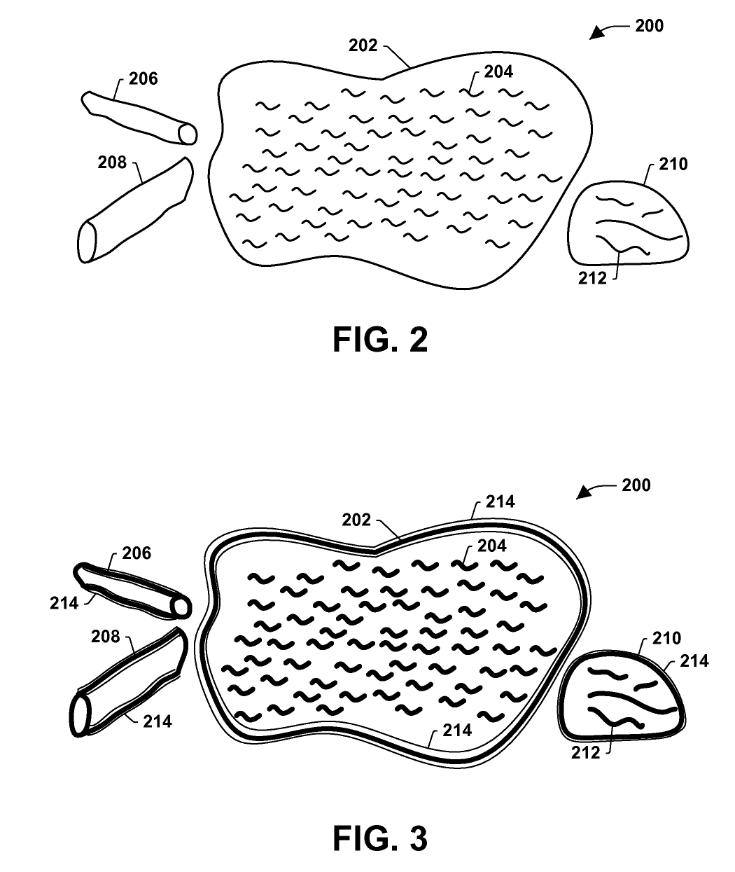

By way of example, FIGS. 2-6 demonstrate at least some of the advantages of enhancing a digital image as provided herein. More particularly, FIGS. 2-6 illustrate a lake view type of scene 200 comprising a body of water 202, waves or ripples 204 on the water 202, logs 206, 208 next to the water 202, and a stone 210 next to the water 202 with some texture or ridges 212 on the stone 210. FIG. 2 illustrates the original image before any processing is performed. FIG. 3 illustrates the image processed with conventional techniques, such that undesired ringing artifacts, perceived as halos, 214 are produced around the edges in the image. That is, one or more “unsharp mask” algorithms that employ non-edge preserving Gaussian smoothing filters are utilized to separate low frequency image components from high frequency image components. However, since the high frequency components comprise both the textures and the edges within the image when obtained with a non-edge preserving Gaussian smoothing filter, the edges are somewhat overemphasized when the textures are accentuated by adjusting (e.g., increasing) the high frequency components. Accordingly, even though the textures (e.g., ripples 204 on the water 202 and features 212 on the stone 210) are darkened or emphasized as desired in FIG. 3, the edges of the stone 210, lake 202, and logs 206, 208 are emphasized to such an extent that they exhibit ringing effects or halos. It can be appreciated that this is undesirable as it can, among other things, make the image appear to have unwanted erroneous edges as perceived by the human visual system.

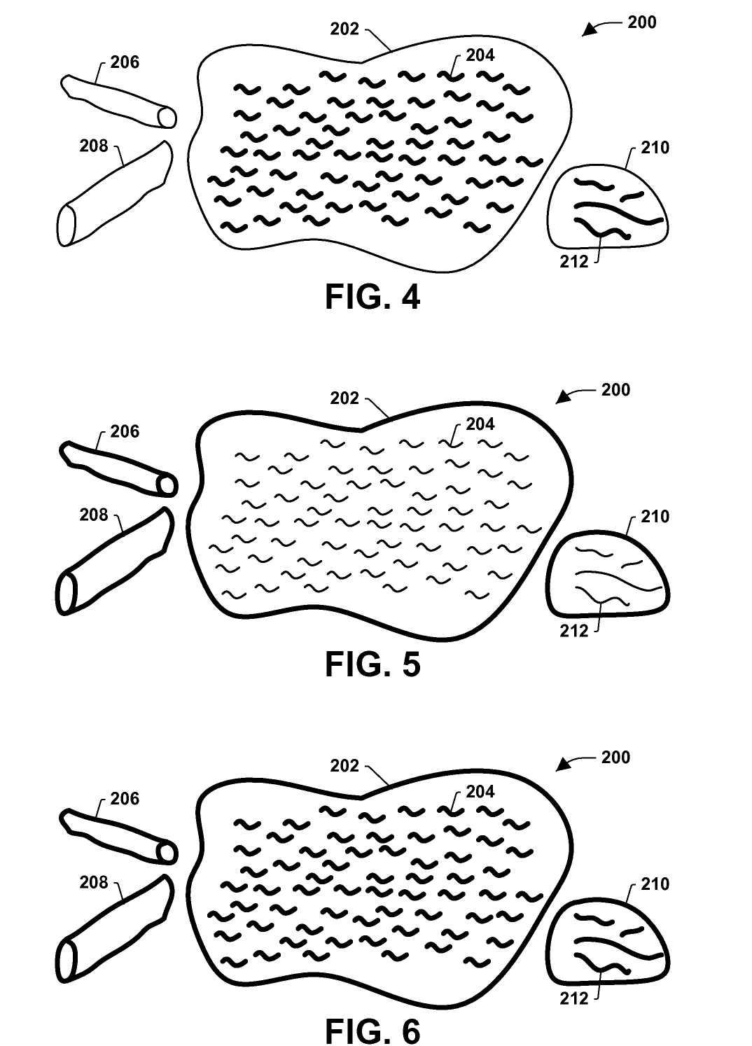

FIG. 4, on the other hand, illustrates the scene 200 after merely textures in the image are enhanced using the method described herein to achieve a more desirable behavior. That is, a bilateral filter is applied to the original image to establish a detail feature image and a large-scale feature image, where the image's textures are primarily comprised within the detail image and edges within the image are primarily comprised within the large-scale image. Accordingly, merely the detail image is adjusted to render the image illustrated in FIG. 4 wherein the textures of the ripples 204 on the water 202 and the features 212 of the stone 210 appear darker. It will be appreciated, however, that very little, if any, of the edges may be visible in an actual detail feature image since substantially all of the large-scale features may be removed from the original image to generate a detail feature image. Nevertheless, edges or large-scale features are included in the detail feature image of FIG. 4 for purposes of illustration.

It will also be appreciated that while enhancements are generally illustrated herein as features having a heavier line weight or that are darker, enhancements or adjustments as mentioned herein are not intended to be so limited. Rather, the more salient point is that the textures and edges can be adjusted independently of one another, regardless of whether they are darkened, lightened, shaded, hatched, colored, etc. Accordingly, unlike the situation in FIG. 3, where enhancing textures 204, 212 also enhances edges and thus leads to halos or ringing effects 214 (e.g., because both textures and edges are comprised within the high frequency components), the textures 204, 212 are enhanced independently of edges in FIG. 4 so that the appearance of halos or ringing effects is substantially mitigated.

FIG. 5 illustrates the image 200 where the edges within the scene are enhanced (instead of the textures). That is, after the bilateral filter is applied to the original image to obtain the detail and large-scale feature images, the large-scale feature image is independently adjusted to enhance the edges within the image. Similar to the discussion with regard to FIG. 4, it will be appreciated that very little if any of the texture may be visible in an actual large-scale feature image since substantially all of the details may be removed or subtracted out of the original image in rendering a large-scale feature image. Nevertheless, textures or detail features are included in the large-scale feature image of FIG. 5 for purposes of illustration.

After the detail feature image (e.g., textures) and the large-scale feature image (e.g., edges) within the image are adjusted independently as desired (FIGS. 4 and 5, respectively), these images are recombined to render the adjusted image which is illustrated in FIG. 6. Again, it will be appreciated that while both the textures and edges within the image are illustrated as being darkened in FIG. 6, the important point is that the textures and the edges can be adjusted independently of one another. Accordingly, the textures within the image could just have easily been made very light relative to the edges and vice versa (while mitigating the appearance/occurrence of halos or ringing effects).

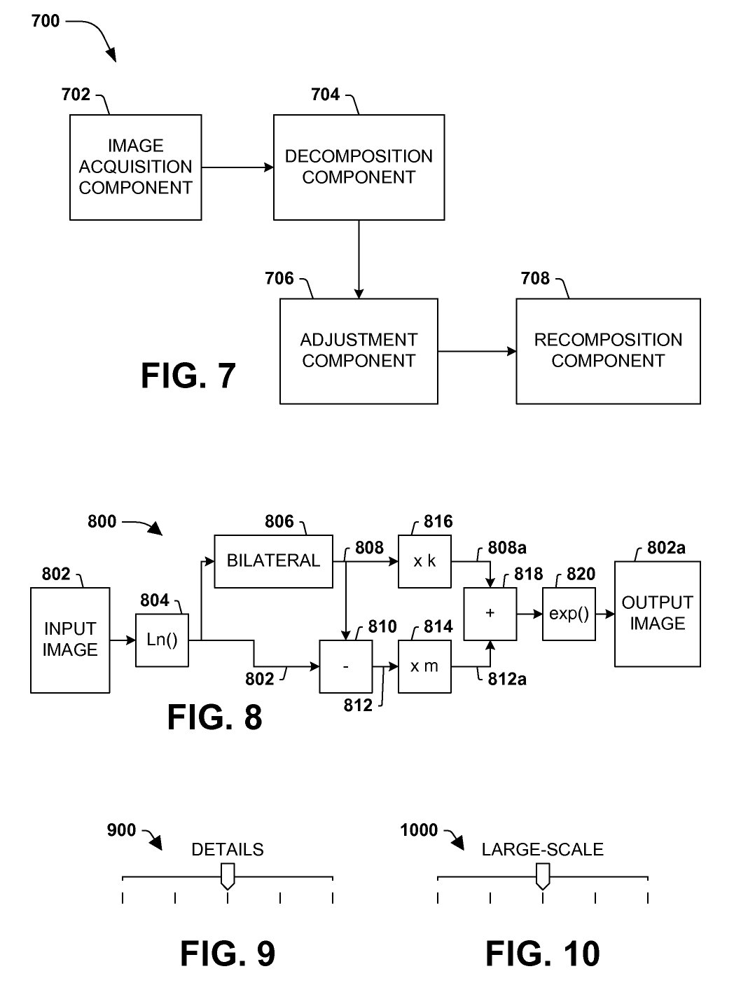

Turning to FIG. 7, a schematic block diagram of an exemplary system 700 configured to enhance the appearance of a digital image is illustrated. The system 700 comprises an image acquisition component 702, a decomposition component 704, an adjustment component 706, and a re-composition component 708. The image acquisition component 702 obtains the base image to be acted upon and then forwards the same to the decomposition component 704. The decomposition component 704 implements bilateral filtering to break the original image into two component images: a detail feature image and a large-scale feature image, where the image's textures are primarily comprised within the detail feature image and the image's edges are primarily comprised within the large-scale feature image. More particularly, bilateral filtering renders the large-scale features, and the detail features are thus determined from the difference between the original image and the large-scale features.

The decomposition component 704 outputs the detail and large-scale feature images to the adjustment component 706 which is configured to adjust, respectively, the textures and edges of the image (independently of one another). With the textures and edges adjusted as desired, the (adjusted) detail and large-scale feature images are forwarded from the adjustment component 706 to the re-composition component 708. The re-composition component 708 renders the adjusted original image from the adjusted detail and large-scale feature images.

FIG. 8 is a functional block diagram 800 illustrating an exemplary technique for enhancing the appearance of a digital image. The original image 802 to be acted upon is input, and an optional first logarithmic operation 804 is performed on the image 802 in the illustrated example. It will be appreciated that performing the logarithmic operation may be advantageous to accommodate subsequent operations, for example. A bilateral filter 806, for example, is then applied to the logarithmic input image, where it is desirable to perform this processing in the ln(x) log domain for two reasons. First, the bilateral filter defines radiometric differences (edges) in scale space, therefore, edges are based on percentage differences, not absolute differences. Secondly, the difference between the original image and the bilateral image in scale space (the detail features) will instead be a modulation field of the original image, as opposed to absolute differences. In this manner, the magnitude of the details in the output image will adapt to the local intensity of the large-scale features (which, perceptually, is desirable).

It will be appreciated that the bilateral filter is an edge-preserving smoothing filter in both domain and range. In the domain (spatial), it acts as a typical Gaussian smoothing filter. In the domain (radiometric differences), it merely combines pixel values together that are close to the value at the center of the kernel, based upon a Gaussian distribution. This serves to mitigate smoothing across edges. Note that it is assumed that the scaling of the image components is a linear function in scale space (resulting in a gamma remapping in linear space). For consistency within results when dealing with ln(x) space, image values may be scaled between 0 and 1. Also, prior to scaling, the minimum possible image value should be made larger than 0, as 0 is undefined in ln(x) space.

The bilateral filter comprises:

$$B ( I , s , {σ}_{k} , \text{?} , Ω ) = \frac{\sum \text{?} g ( ‖ p - s ‖ , {σ}_{k} ) g ( {I}_{p} - {I}_{s} , {σ}_{k} ) {I}_{p}}{\sum \text{?} ( ‖ p - s ‖ , {σ}_{k} ) g ( {I}_{p} - {I}_{s} , {σ}_{k} )}$$

$$g ( x , σ ) = e \text{?}$$

$$\text{?} \text{indicates text missing or illegible when filed}$$

Where some of the nomenclature is defined as follows:

BO Bilateral Filter

gO Gaussian or Pseudo-Gaussian Function (normalization is unnecessary)

I Original Input Image

s Pixel Being Solved

p A Pixel within the Kernel Ω Surrounding s

Ω The Kernel surrounding s (Typically a Square Region)

σₕ The Spatial Falloff of the Bilateral Filter (e.g., 4 pixels for 1 Megapixel resolution images). This may vary depending on how far the subject was from the camera when the image was acquired and what the image comprises. For example, if the subject is far away from the camera then the magnitude of this coefficient may be lower. Similarly, if the subject is detected to be a face (e.g., through facial recognition software) then certain settings deemed appropriate for facial/portrait images may be used.

σᵢ The Radiometric Difference Falloff of the Bilateral Filter (e.g., 0.3)

k Large-Scale Feature Scalar

m Detail Feature Scalar

Accordingly, the large-scale features 808 of the image are output from the bilateral filter 806. The large-scale features of the image are at times also referred to as the large-scale feature image. In establishing the large-scale feature image 808, pixels which are similar to one another are combined together to substantially remove texture, leaving regions of similar intensity that have sharp edges but little to nothing else. This promotes edge retention and is accomplished in a manner that is much faster than other edge preservation techniques, such as anisotropic diffusion, for example. It will be appreciated that large-scale features generally comprise the information (e.g., edges) that most humans utilize to recognize objects.

The large-scale feature image 808 is applied to a differencing operation 810, as is the original image 802. Since the large-scale feature image 808 substantially comprises the edges of the image, the difference between this image 808 and the original image 802 corresponds to the textures of the image, which is referred to as the detail feature image. The detail feature image 812 generally comprises the subtle variations differentiating pixels whose values are near, but not necessarily similar, to one another. The detail feature image 812 is output from the differencing block 810 and is fed to a multiplier block 814 to selectively adjust the magnitude thereof. In the illustrated example, the detail feature image 812 is multiplied by a constant m in the multiplier block 814 to increase (e.g., m>1) or decrease (e.g., m<1) the magnitude of the detail feature image, and thus the relative amount of texture presented therein.

Similarly, the large-scale feature image 808 is applied to a multiplier block 816 to selectively adjust the magnitude thereof. In the illustrated example, the large-scale feature image 808 is multiplied by a constant k in the multiplier block 816 to increase (e.g., k>1) or decrease (e.g., k<1) the magnitude of the large-scale feature image, and thus the intensity of the edges presented therein. The adjusted large-scale feature image 808a and the adjusted detail feature image 812a are applied to an addition block 818 and a second optional logarithmic operation (e.g., expo) 820 is performed to recombine the images and render the original, but adjusted, image 802a back in the linear domain. Nevertheless, the first 804 and second 820 logarithmic operations are said to be optional as the foregoing calculations can also be performed in linear space.

It will be appreciated that the resultant image R 802a (e.g., the original adjusted image) can be obtained in the linear domain according to R=k(B(I,σₕ,σᵢ))+m(I−B(I,σₕ,σᵢ)).

The large-scale feature image 808 L is determined according to L=B(I,σₕ,σᵢwhere B(Input,σₕ,σᵢ)s is the bilateral filter.

The detail feature image D 812 is thus determined according to D=I−L, where I is the input image 802 and L is the large-scale feature image 808.

The resultant image R 802a can also be thought of as R=(kL+mD), where m 814 is the detail image scalar, and k 816 is the large-scale image scalar

The adjusted large-scale feature image 808a can thus be thought of as L^{σ}=kL and the adjusted detail feature image 812a can be thought of as D^{θ}=mD such that the resultant image R 802a corresponds to R=L^{σ}+D^{θ}.

In the logarithmic domain, the resultant image R 802a can be determined according to R=exp(k(B(ln(I),σₕ,σᵢ))+m(ln(I)−B(ln(I),σₕ,σᵢ))).

The large-scale feature image 808 L is determined according to L=B(ln(I),σₕ,σᵢ) and the detail feature image D 812 is determined according to D=ln(I)−L, where I is the input image 802 and L is the large-scale feature image 808. Nevertheless, it will be appreciated that L and D in the logarithmic domain are different than L and D in the linear domain (above).

The resultant image R 802a can also be thought of as R=exp(kL+mD), where m 814 is the detail image scalar, and k 816 is the large-scale image scalar.

The adjusted large-scale feature image 808a can thus be thought of as L^{σ}=kL and the adjusted detail feature image 812a can be thought of as D^{θ}=mD such that the resultant image R 802a corresponds to R=exp(L^{θ}+D^{σ}).

It will be appreciated that as an edge preserving filter, the bilateral filter provides a more perceptually-correct adjustment to the texture of digital images than traditional “unsharp mask” algorithms which are based on non-edge-preserving Gaussian filters. It will also be appreciated that a graphics processing unit or GPU of a computer can be utilized for the numerical processing necessary to implement the provisions set forth herein.

Turning to FIGS. 9 and 10, a couple of exemplary slider controls are illustrated that can be implemented to facilitate independent adjustments to the appearance of a digital image. For example, slider 900 can be moved to the left or to the right to decrease or increase, respectively, the relative magnitude of textures visible in the image. Similarly, slider 1000 can be moved to the left or to the right to decrease or increase, respectively, the relative magnitude of edges visible in the image. It will be appreciated that since the textures and edges are adjusted independently of one another, the emergence of halos or ringing effects is mitigated. In one example, such sliders can have presets depending on the type of imaging application at issue. It will be appreciated that the illustrated sliders are merely an example of one of many types of interfaces that a user could interact with to selectively adjust the large-scale and detail features within an image.

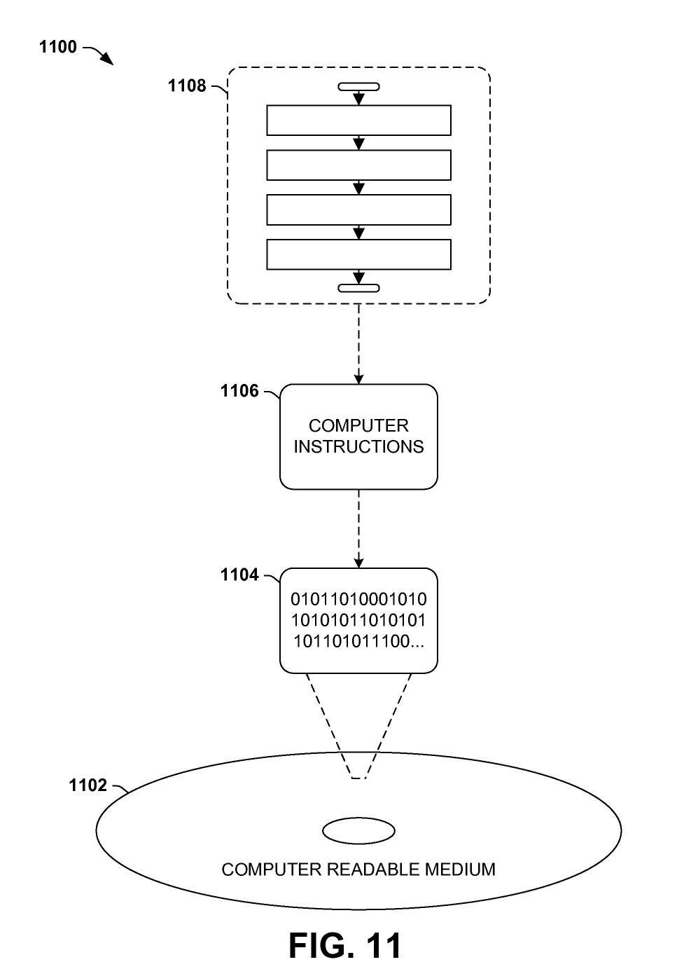

Still another embodiment involves a computer-readable medium comprising processor-executable instructions configured to apply one or more of the techniques presented herein. An exemplary computer-readable medium that may be devised in these ways is illustrated in FIG. 11, wherein the implementation comprises a computer-readable medium 1102 (e.g., a CD-R, DVD-R, or a platter of a hard disk drive), on which is encoded computer-readable data 1104. This computer-readable data 1104 in turn comprises a set of computer instructions 1106 configured to operate according to one or more of the principles set forth herein. In one such embodiment 1100, the processor-executable instructions 1106 may be configured to perform a method, such as the exemplary method 100 of FIG. 1, for example. In another such embodiment, the processor-executable instructions 1106 may be configured to implement a system, such as the exemplary system 700 of FIG. 7, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

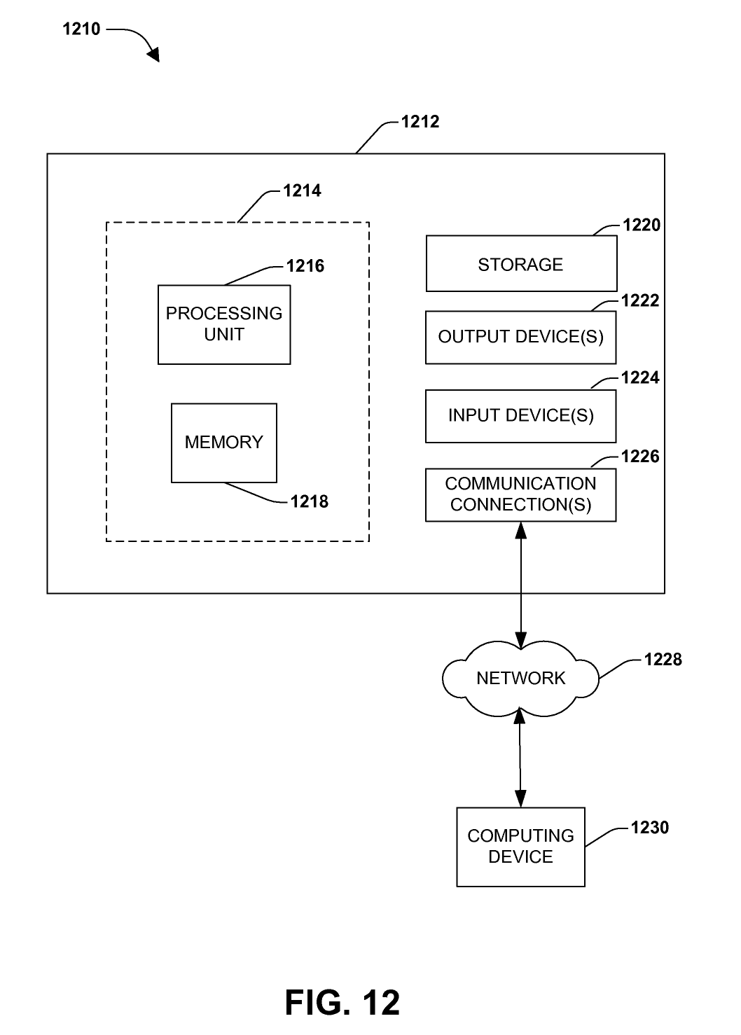

FIG. 12 and the following discussion provide a brief, general description of a suitable computing environment to implement embodiments of one or more of the provisions set forth herein. The operating environment of FIG. 12 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 12 illustrates an example of a system 1210 comprising a computing device 1212 configured to implement one or more embodiments provided herein. In one configuration, computing device 1212 includes at least one processing unit 1216 and memory 1218. It will be appreciated that the processing unit 1216 may comprise a graphics processing unit or GPU to perform at least some of the numerically intensive processing necessary to implement the provisions set forth herein. Depending on the exact configuration and type of computing device, memory 1218 may be volatile (such as RAM, for example), non-volatile (such as ROM, flash memory, etc., for example) or some combination of the two. This configuration is illustrated in FIG. 12 by dashed line 1214.

In other embodiments, device 1212 may include additional features and/or functionality. For example, device 1212 may also include additional storage (e.g., removable and/or non-removable) including, but not limited to, magnetic storage, optical storage, and the like. Such additional storage is illustrated in FIG. 12 by storage 1220. In one embodiment, computer readable instructions to implement one or more embodiments provided herein may be in storage 1220. Storage 1220 may also store other computer readable instructions to implement an operating system, an application program, and the like. Computer readable instructions may be loaded in memory 1218 for execution by processing unit 1216, for example.

The term “computer readable media” as used herein includes computer storage media. Computer storage media includes volatile and nonvolatile, removable and non-removable media implemented in any method or technology for storage of information such as computer readable instructions or other data. Memory 1218 and storage 1220 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1212. Any such computer storage media may be part of device 1212.

Device 1212 may also include communication connection(s) 1226 that allows device 1212 to communicate with other devices. Communication connection(s) 1226 may include, but is not limited to, a modem, a Network Interface Card (NIC), an integrated network interface, a radio frequency transmitter/receiver, an infrared port, a USB connection, or other interfaces for connecting computing device 1212 to other computing devices. Communication connection(s) 1226 may include a wired connection or a wireless connection. Communication connection(s) 1226 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1212 may include input device(s) 1224 such as keyboard, mouse, pen, voice input device, touch input device, infrared cameras, video input devices, and/or any other input device. Output device(s) 1222 such as one or more displays, speakers, printers, and/or any other output device may also be included in device 1212. Input device(s) 1224 and output device(s) 1222 may be connected to device 1212 via a wired connection, wireless connection, or any combination thereof. In one embodiment, an input device or an output device from another computing device may be used as input device(s) 1224 or output device(s) 1222 for computing device 1212.

Components of computing device 1212 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1212 may be interconnected by a network. For example, memory 1218 may be comprised of multiple physical memory units located in different physical locations interconnected by a network.

Those skilled in the art will realize that storage devices utilized to store computer readable instructions may be distributed across a network. For example, a computing device 1230 accessible via network 1228 may store computer readable instructions to implement one or more embodiments provided herein. Computing device 1212 may access computing device 1230 and download a part or all of the computer readable instructions for execution. Alternatively, computing device 1212 may download pieces of the computer readable instructions, as needed, or some instructions may be executed at computing device 1212 and some at computing device 1230.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for enhancing a digital image, comprising:
decomposing the image into a detail feature image and a large-scale feature image;
independently adjusting at least one of the detail feature image and the large-scale feature image; and
recomposing the detail feature image and the large-scale feature image into an enhanced composite image.

2. The method of claim 1, the detail feature image comprising textures of the image and the large-scale feature image comprising edges of the image.

3. The method of claim 2, decomposing the image comprising applying a bilateral filter to the image.

4. The method of claim 2, decomposing the image comprising:
applying a bilateral filter to the image to obtain the large-scale feature image; and
subtracting the large-scale feature image from the original image to obtain the detail feature image.

5. The method of claim 3, the bilateral filter comprising:
$$B ( I , s , {σ}_{k} , \text{?} , Ω ) = \frac{\sum \text{?} g ( ‖ p - s ‖ , {σ}_{k} ) g ( {I}_{p} - {I}_{s} , {σ}_{k} ) {I}_{p}}{\sum \text{?} ( ‖ p - s ‖ , {σ}_{k} ) g ( {I}_{p} - {I}_{s} , {σ}_{k} )} , \\ \text{?} \text{indicates text missing or illegible when filed}$$
where
gO=Gaussian or Pseudo-Gaussian Function
I=Original Input Image
s=Pixel Being Solved
p=A Pixel within the Kernel Ω Surrounding s
Ω=Kernel surrounding s
σₕ=Spatial Falloff of Bilateral Filter
σᵢ=Radiometric Difference Falloff of Bilateral Filter
k=Large-Scale Feature Scalar
m=Detail Feature Scalar

6. The method of claim 1, adjusting the detail feature image comprising selectively multiplying by a constant k.

7. The method of claim 1, adjusting the large-scale feature image comprising selectively multiplying by a constant m.

8. The method of claim 3, comprising performing a first logarithmic operation on the digital image before applying the bilateral filter and performing a second logarithmic operation on the digital image after recomposing the detail and large-scale feature images.

9. The method of claim 3, comprising determining the enhanced composite image R according to R=k(B(I,σₕ,σᵢ))+m(I−B(I,σₕ,σᵢ)), where the large-scale feature image L is determined according to L=B(I,σₕ,σᵢ) and the detail feature image D is determined according to D=I−L, where B(Input,σₕ,σᵢ)θ is the bilateral filter, I is the original digital image, m is a detail image scalar, and k is a large-scale image scalar.

10. The method of claim 8, comprising determining the enhanced composite image R according to R=exp(k(B(ln(I),σₕ,σᵢ))+m(ln(I)−b(ln(I),σₕ,σᵢ))), where the large-scale feature image L is determined according to L=B(ln(I),σₕ,σᵢ) and the detail feature image D is determined according to D=ln(I)−L, where I is the original digital image, m is a detail image scalar, and k is a large-scale image scalar.

11. A system configured to enhance a digital image, comprising:
a decomposition component configured to decompose a digital image into a detail feature image and a large-scale feature image;
an adjustment component configured to independently adjust at least one of the detail feature image and the large-scale feature image; and
a recomposition component configured to recompose the detail feature image and the large-scale feature image into an enhanced composite image.

12. The system of claim 11, the detail feature image comprising textures of the image and the large-scale feature image comprising edges of the image.

13. The system of claim 12, the decomposition component configured to apply a bilateral filter to the digital image to decompose the image.

14. The system of claim 12, the decomposition component configured to apply a bilateral filter to the digital image to obtain the large-scale feature image and to subtract the large-scale feature image from the original image to obtain the detail feature image.

15. The system of claim 12, the bilateral filter comprising:
$$B ( I , s , {σ}_{k} , \text{?} , Ω ) = \frac{\sum \text{?} g ( ‖ p - s ‖ , {σ}_{k} ) g ( {I}_{p} - {I}_{s} , {σ}_{k} ) {I}_{p}}{\sum \text{?} ( ‖ p - s ‖ , {σ}_{k} ) g ( {I}_{p} - {I}_{s} , {σ}_{k} )} , \\ \text{?} \text{indicates text missing or illegible when filed}$$
where
gO=Gaussian or Pseudo-Gaussian Function
I=Original Input Image
s=Pixel Being Solved
p=A Pixel within the Kernel Ω Surrounding s
Ω=Kernel surrounding s
σₕ=Spatial Falloff of Bilateral Filter
σᵢ=Radiometric Difference Falloff of Bilateral Filter
k=Large-Scale Feature Scalar
m=Detail Feature Scalar

16. The system of claim 12, the adjustment component configured to selectively multiply the detail feature image by a constant k and the large-scale image by a constant m.

17. The system of claim 12, comprising:
a first logarithmic component configured to perform a first logarithmic operation on the digital image before it is decomposed; and
a second logarithmic component configured to perform a second logarithmic operation on the digital image after it is recomposed.

18. The system of claim 12, comprising:
a first slider control configured to facilitate user control over selectively adjusting the detail feature image; and
a second slider control configured to facilitate user control over selectively adjusting the large-scale feature image.

19. A method for enhancing a digital image, comprising:
applying a bilateral filter to the original image to produce a large-scale feature image, the bilateral filter comprising:
$$B ( I , s , {σ}_{k} , \text{?} , Ω ) = \frac{\sum \text{?} g ( ‖ p - s ‖ , {σ}_{k} ) g ( {I}_{p} - {I}_{s} , {σ}_{k} ) {I}_{p}}{\sum \text{?} ( ‖ p - s ‖ , {σ}_{k} ) g ( {I}_{p} - {I}_{s} , {σ}_{k} )} , \\ \text{?} \text{indicates text missing or illegible when filed}$$
where
gO=Gaussian or Pseudo-Gaussian Function
I=Original Input Image
s=Pixel Being Solved
p=A Pixel within the Kernel n Surrounding s
Ω=Kernel surrounding s
σₕ=Spatial Falloff of Bilateral Filter
σᵢ=Radiometric Difference Falloff of Bilateral Filter
k=Large-Scale Feature Scalar
m=Detail Feature Scalar;
subtracting the large-scale feature image from the original image to produce a detail feature image;
independently adjusting at least one of the detail feature image and the large-scale feature image; and
recomposing the adjusted detail feature image and large-scale feature image to render the enhanced original image.

20. The method of claim 19, comprising:
performing a first logarithmic operation on the digital image before applying the bilateral filter; and
performing a second logarithmic operation on the digital image after recomposing the detail and large-scale feature images.
